(19) United States
(12) Patent Application Publication
(10) Pub. No.: US 2007/0098155 A1
(43) Pub. Date: May 3, 2007

(54) Data processing device and data processing method

(76) Inventors: Yukiyoshi Nagasawa, Kyoto (JP); Tomoharu Kawada, Osaka (JP)

Correspondence Address: MCDERMOTT WILL & EMERY LLP, 600 13TH STREET, N.W., WASHINGTON, DC, 20005-3096, US

(21) Appl. No.: 11/491,935

(22) Filed: Jul. 25, 2006

(30) Foreign Application Priority Data
Oct. 19, 2005 (JP) 2005-304721

(51) Int. Cl. H04L 9/28; H04K 1/10; H04K 1/06; H04L 9/00; H04K 1/04; H04K 1/00

(52) U.S. Cl. 380/33; 380/28; 380/37

(57) ABSTRACT

Input data is stored in input buffers provided for respective input channels. An operation channel control section controls an input data selector to allow the data stored in the input buffers to be input into an operation circuit by the block unit in a time-division manner. The operation circuit encrypts (or decrypts) the input data with an encryption key given from an encryption key selector.

### CROSS-REFERENCE TO RELATED APPLICATIONS

This application claims priority under 35 U.S.C. §119 on Patent Application No. 2005-304721 filed in Japan on Oct. 19, 2005, the entire contents of which are hereby incorporated by reference.

### BACKGROUND OF THE INVENTION

The present invention relates to a data processing device and data processing method for performing encryption or decryption under a block encryption scheme.

In recent years, with the progress of networking typified by the widespread use of the Internet, various types of information have been increasingly digitized. Under such circumstances, more importance is being placed on protection against leakage and tampering of information and copyright protection of contents. As such protection measures, encryption technology has become absolutely essential.

As the encryption technology, the Data Encryption Standard (DES) and the Advanced Encryption Standard (AES) as block encryption schemes are well known. Block encryption schemes are characterized in that a plaintext is divided into blocks of a fixed length to perform encryption or decryption in blocks.

The encryption schemes are considered as robust because it is sufficiently difficult to guess a plaintext from a ciphertext. However, since encryption of the same plaintext with the same encryption key will result in the same ciphertext under these encryption schemes, there are concerns that the encryption strength might be lowered due to statistical properties revealed from identical patterns in a plaintext.

As methods for securing the encryption strength, four encryption use modes are standardized in ISO 10116: an electronic codebook (ECB) mode, a cipher block chaining (CBC) mode, a cipher feedback (CFB) mode and an output feedback (OFB) mode.

The modes excluding the ECB mode, that is, the CBC, CFB and OFB modes are modes in which the result of encryption operation of data divided into blocks or information obtained in the course of the processing is fed back, to perform encryption in a chain and thus enhance the encryption strength.

Data processing devices for performing encryption and decryption as described above are asked for operation (encryption and decryption) processing for stream data from a plurality of channels (lines) in some cases. A data processing device for encrypting stream data from a plurality of channels, for example, is known. This device includes an input buffer, an operation circuit (circuit for encrypting or decrypting data in blocks) and an output buffer (FIFO buffer, for example) all provided for each channel, and encrypts multiplexed data on each channel divided into time slots (see Japanese Laid-Open Patent Publication No. 11-88320).

However, the above data processing device has the following problems. To encrypt real time data such as AV stream data flowing on a plurality of channels, encryption processing means of the number equal to the number of channels are required to secure the real time nature of the data. This increases the circuit scale.

Moreover, to encrypt data divided into time slots, an input buffer having a capacity of one time slot or more must be provided for each operation circuit. This also increases the circuit scale.

### SUMMARY OF THE INVENTION

An object of the present invention is providing a data processing device cable of performing encryption (or decryption) processing for real time data from a plurality of channels on a small circuit scale.

The first embodiment of the present invention is directed to a data processing device for performing operation processing of at least either encryption or decryption for data input from a plurality of input channels. The device includes:

an operation circuit for performing the operation processing for given data with a given encryption key by a block unit having a predetermined size;

an input buffer provided for each of the input channels for temporarily storing data received from the corresponding input channel;

an operation channel control section for selecting an input channel for which the operation processing is to be performed in a time-division manner and outputting channel information indicating the selected input channel;

an encryption key selector for outputting an encryption key responsive to the channel information to the operation circuit;

an input data selector for selecting an input buffer corresponding to the input channel indicated by the channel information and outputting data stored in the selected input buffer to the operation circuit;

an output buffer provided for each of the input channels for temporarily storing the result of the operation processing performed for data input from the corresponding input channel; and

an output destination selector for selecting an output buffer corresponding to the input channel indicated by the channel information and outputting the result of the operation processing to the selected output buffer.

With the above configuration, the operation circuit is shared in a time-division manner. This permits encryption (or decryption) processing of real time data from a plurality of channels on a small circuit scale.

The second embodiment of the invention is directed to the data processing device of the first embodiment, further including an operation mode selector for notifying the operation circuit of an operation mode selected among operation modes preset for the respective input channels according to the channel information, the operation mode being an operation mode for performing encryption and an operation mode for performing decryption,

wherein the operation circuit is configured to perform the operation processing according to the operation mode notified of by the operation mode selector.

With the above configuration, it is possible to provide a multi-functional data processing device small in circuit scale that can accept a plurality of channels requiring different operation modes.

The third embodiment of the invention is directed to the data processing device of the first embodiment, wherein the operation circuit is configured to perform the operation processing by a plurality of types of block units.

The fourth embodiment of the invention is directed to the data processing device of the third embodiment, further including a block unit selector for notifying the operation circuit of a block unit selected among block units preset for the respective input channels according to the channel information,

wherein the operation circuit is configured to perform the operation processing according to the block unit notified of by the block unit selector.

With the above configurations, encryption or decryption by different block units can be performed with one operation circuit in a time-division manner. It is therefore possible to implement a multi-functional data processing device small in circuit scale that can accept a plurality of channels requiring encryption or decryption by different block units.

The fifth embodiment of the invention is directed to the data processing device of the first embodiment, further including:

a feedback data buffer provided for each of the input channels for temporarily storing the result of the operation processing;

a feedback data selector for outputting the result of the operation processing stored in a feedback data buffer corresponding to the input channel indicated by the channel information or a given initial value to the operation circuit; and

an initial value selector for outputting the initial value that is a value responsive to the channel information to the feedback data selector,

wherein the operation circuit is configured to perform the operation processing for given data with the output of the feedback data selector and a given encryption key.

The sixth embodiment of the invention is directed to the data processing device of the fifth embodiment, wherein the operation circuit has functions of a plurality of different encryption use modes.

The seventh embodiment of the invention is directed to the data processing device of sixth embodiment, further including an encryption use mode selector for notifying the operation circuit of an encryption use mode selected among the encryption use modes preset for the respective input channels according to the channel information,

wherein the operation circuit is configured to perform the operation processing according to the encryption use mode notified of by the encryption use mode selector.

With the above configurations, the encryption strength of a block encryption scheme can be secured.

The eighth embodiment of the invention is directed to the data processing device of the first embodiment, wherein the operation channel control section is configured to select an input channel for which the operation processing is to be performed in a manner of an input channel corresponding to an input buffer in which data of the block unit has been stored first being selected first.

With the above configuration, encryption or decryption is performed in the order of completion of storing of data of the block unit in an input buffer.

The ninth embodiment of the invention is directed to the data processing device of the first embodiment, wherein the operation channel control section is configured to select an input channel for which the operation processing is to be performed according to priorities given to the respective input channels.

With the above configuration, encryption or decryption is performed according to the priorities given in advance to the respective input channels.

The tenth embodiment of the invention is directed to the data processing device of the first embodiment, wherein the operation channel control section is configured to select an input channel for which the operation processing is to be performed according to priorities given based on the stored data amounts of the input buffers.

With the above configuration, encryption or decryption is performed according to the stored data amounts of the input buffers.

The eleventh embodiment of the invention is directed to the data processing device of the first embodiment, further including an operation clock control section for controlling the frequency of an operation clock for the operation circuit.

The twelfth embodiment of the invention is directed to the data processing device of the eleventh embodiment, further including a channel monitor section for detecting the number of valid input channels among the plurality of input channels, selecting an operation clock for the operation circuit according to the detected number of channels, and notifying the operation clock control section of the selected operation clock,

wherein the operation clock control section is configured to change the operation clock for the operation circuit according to the notification from the channel monitor section.

With the above configurations, the operation clock used in the operation circuit can be changed. This makes it possible to control the power consumption of the operation circuit delicately by setting the operation clock according to the number of valid input channels and the bands of the channels, for example.

The thirteenth embodiment of the invention is directed to a data processing method for performing operation processing of at least either encryption or decryption for data input from a plurality of input channels. The method includes the steps of:

performing the operation processing with an operation circuit for performing the operation processing for given data with a given encryption key by a block unit having a predetermined size (operating step);

temporarily storing data input from the input channels in input buffers provided for the respective input channels (inputting step);

detecting that data of the block unit has been stored in any of the input buffers (detecting step);

issuing an operation request to the operation circuit once storing of data of the block unit in the input buffer has been detected in the detecting step (operation request issuing step);

storing the operation request in an operation request buffer (operation request storing step)

selecting one operation request from operation requests stored in the operation request buffer in a time-division manner and outputting channel information indicating the input channel corresponding to the selected operation request (operation channel control step);

outputting an encryption key responsive to the channel information to the operation circuit (encryption key outputting step);

selecting an input buffer corresponding to the input channel indicated by the channel information and outputting data stored in the selected input buffer to the operation circuit (input data selecting step);

selecting an output buffer corresponding to the input channel indicated by the channel information among output buffers provided for the respective input channels and outputting a result of the operation processing to the selected output buffer (outputting step); and

deleting the operation request for the terminated operation processing from the operation request buffer (operation request deleting step).

According to the above method, the operation circuit is shared in a time-division manner. It is therefore possible to implement a data processing device capable of performing encryption (or decryption) processing of real time data from a plurality of channels on a small circuit scale.

### BRIEF DESCRIPTION OF THE DRAWINGS

FIG. 1 is a block diagram of a data processing device of Embodiment 1 of the present invention.

FIG. 2 is a block diagram of an operation channel control section in Embodiment 1.

FIG. 3 is a flowchart showing the operation of the data processing device of Embodiment 1.

FIG. 4 is a block diagram of a data processing device of Embodiment 2 of the present invention.

FIG. 5 is a block diagram of a data processing device of Embodiment 3 of the present invention.

FIG. 6 is a block diagram of a data processing device of Embodiment 4 of the present invention.

FIG. 7 is a block diagram of a data processing device of which an operation circuit is adaptive to CBC-mode encryption operation processing.

FIG. 8 is a block diagram of a data processing device of which an operation circuit is adaptive to CBC-mode decryption operation processing.

FIG. 9 is a block diagram of a data processing device of Embodiment 5 of the present invention.

FIG. 10 is a block diagram of a data processing device of Embodiment 6 of the present invention.

FIG. 11 is a block diagram of a data processing device of Embodiment 7 of the present invention.

FIG. 12 is a block diagram of an alteration to the operation channel control section.

FIG. 13 is a block diagram of another alteration to the operation channel control section.

### DESCRIPTION OF THE PREFERRED EMBODIMENTS

Hereinafter, preferred embodiments of the present invention will be described with reference to the accompanying drawings.

### Embodiment 1

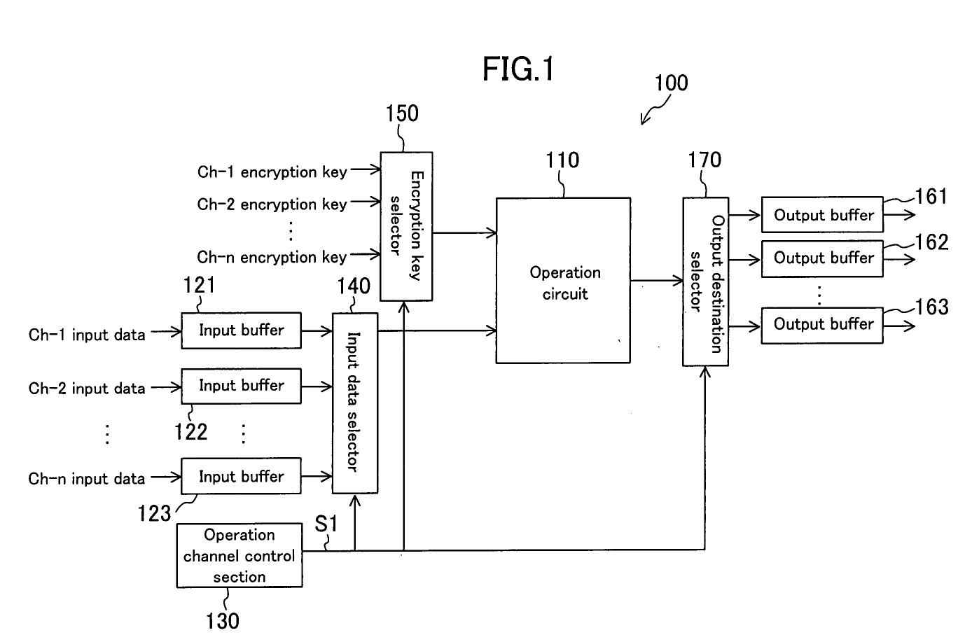

FIG. 1 is a block diagram of a data processing device 100 of Embodiment 1 of the present invention. Referring to FIG. 1, the data processing device 100 includes an operation circuit 110, input buffers 121 to 123, an operation channel control section 130, an input data selector 140, an encryption key selector 150, output buffers 161 to 163 and an output destination selector 170.

The operation circuit 110 performs operation (encryption or decryption) for data input thereinto with an encryption key supplied and outputs the operation result.

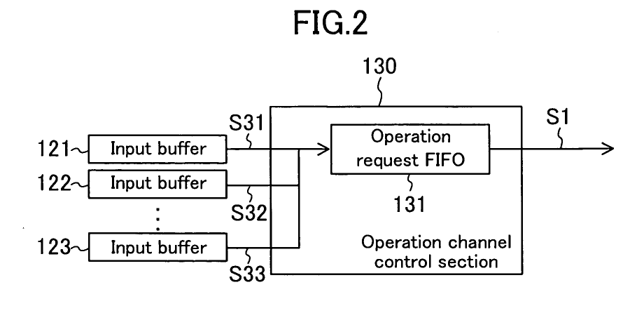

The input buffers 121 to 123, provided for respective channels (channels 1 to n), hold input data received from the corresponding channels (ch-1 input data to ch-n input data). Each of the input buffers 121 to 123 has a capacity large enough to hold data of the block unit for the encryption (or decryption) with the operation circuit 110. Once having stored data of the block unit therein, the input buffers 121 to 123 output respective requests for encryption (or decryption) to the operation channel control section 130 as operation requests (S31 to S33, see FIG. 2).

As shown in FIG. 2, the operation channel control section 130, composed of an operation request FIFO 131, selects a channel of which input data is to be processed in response to an operation request (any of S31 to S33) and outputs the selected channel number as channel information S1. More specifically, when detecting an operation request (any of S31 to S33), the operation channel control section 130 stores the operation request in the operation request FIFO 131 in the order of detection. The operation channel control section 130 then selects a channel that has issued the oldest operation request stored in the operation request FIFO 131 at predetermined time intervals (that is, in a time-division manner) and outputs the selected channel number as the channel information S1.

The input data selector 140 outputs input data held in the input buffer (any of the input buffers 121 to 123) corresponding to the channel indicated by the channel information S1 received from the operation channel control section 130 to the operation circuit 110.

The encryption key selector 150 selects an encryption key for the channel indicated by the channel information S1 received from the operation channel control section 130 among encryption keys preset for the respective channels (ch-1 encryption key to ch-n encryption key), and outputs the selected encryption key to the operation circuit 110.

The output buffers 161 to 163, provided for the respective channels, hold the encrypted (or decrypted) results (operation results) of the input data from the corresponding channels.

The output destination selector 170 selects an output buffer (any of the output buffers 161 to 163) corresponding to the channel indicated by the channel information S1, and outputs the operation result from the operation circuit 110.

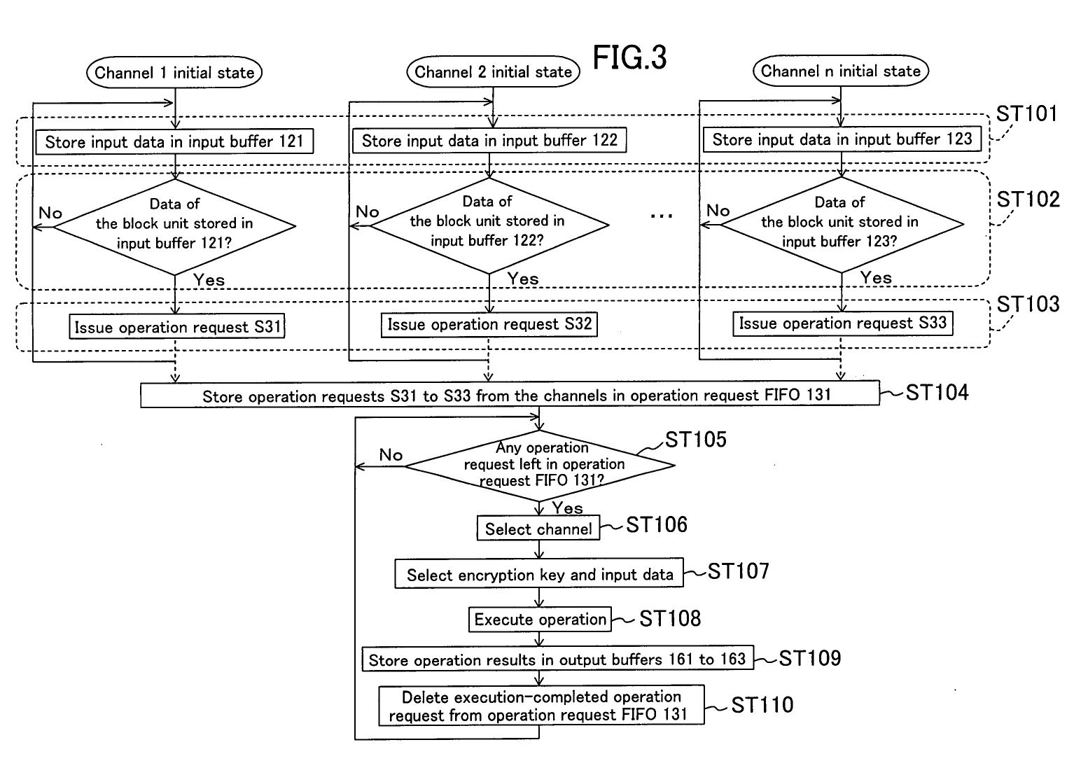

The operation of the data processing device 100 described above will be described with reference to the flowchart of FIG. 3.

Input data from a plurality of channels (channels 1 to n) (ch-1 input data to ch-n input data) are sequentially stored in the input buffers 121 to 123 prepared for the respective channels (ST101).

Each of the input buffers 121 to 123 determines whether or not data of the block unit has been stored (ST102). If data of the block unit has been stored, the input buffer issues an operation request (any of S31 to S33) to the operation channel control section 130 (ST103).

Once detecting an operation request (any of S31 to S33), the operation channel control section 130 stores the operation request in the operation request FIFO 131 in the order of detection (ST104). The operation channel control section 130 also checks the operation request FIFO 131 (ST105) and, if there is any operation request stored in the operation request FIFO 131, outputs the number of the channel that has issued the oldest operation request stored therein as the channel information S1 (ST106).

The encryption key selector 150 selects an appropriate encryption key among ch-1 encryption key to ch-n encryption key according to the channel information S1, and outputs the selected encryption key to the operation circuit 110. Also, the input data selector 140 selects input data in the input buffer (any of the input buffers 121 to 123) corresponding to the channel indicated by the channel information S1, and outputs the selected input data to the operation circuit 110 (ST107).

The operation circuit 110 performs encryption (or decryption) operation under a block encryption scheme for the input data received via the input data selector 140 with the encryption key received from the encryption key selector 150, and outputs the operation result to the output destination selector 170 (ST108).

The output destination selector 170 outputs the received operation result to an output buffer (any of the output buffers 161 to 163) for the channel indicated by the channel information S1 (ST109).

Once the operation terminates, the operation channel control section 130 deletes the operation request corresponding to the channel for which the operation has been terminated (the oldest operation request) from the operation request FIFO 131 (ST110). The process then returns to ST105.

As described above, the data processing device 100 performs encryption (or decryption) processing by changing the channel every block unit, and this permits sharing of the operation circuit among the channels. In other words, input data from a plurality of channels can be encrypted (or decrypted) on a smaller circuit scale.

Also, since the unit of operation processing for each channel is the block unit described above, each input buffer may have a capacity independent of the data length of the input data like the time slot. In other words, the scale of the input buffer can be reduced.

The operation circuit 110 may have both functions of encryption operation and decryption operation, or may have only one of the functions. For example, in the case of the operation circuit 110 having only the function of encryption operation, the data processing device serves as a device capable of encrypting data from a plurality of channels. In this case, the scale can be reduced by the size of circuits required for the function of decryption operation. Likewise, in the case of the operation circuit 110 having only the function of decryption operation, the data processing device serves as a device capable of decrypting data from a plurality of channels. In this case, the scale can be reduced by the size of circuits required for the function of encryption operation.

### Embodiment 2

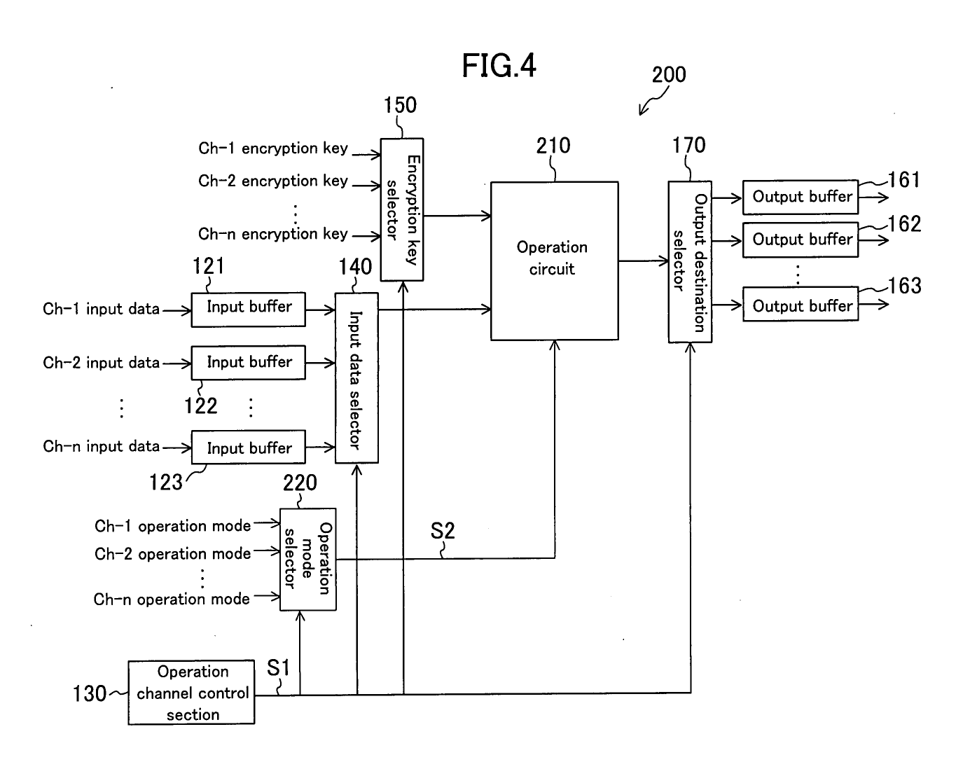

FIG. 4 is a block diagram of a data processing device 200 of Embodiment 2 of the present invention. Referring to FIG. 4, the data processing device 200 is different from the data processing device 100 in that an operation mode selector 220 is additionally provided and also an operation circuit 210 is provided in place of the operation circuit 110.

Note that in this embodiment as well as all embodiments and alterations to follow, components having substantially the same functions as those in Embodiment 1 are denoted by the same reference numerals and description of such components is omitted.

The operation circuit 210 is an operation circuit having both functions of encryption operation and decryption operation, in which operation modes (a mode for performing encryption operation and a mode for performing decryption operation) are switched to each other according to an operation mode signal S2 (to be described later) output from the operation mode selector 220. The operation circuit 210 performs operation (encryption or decryption) with an encryption key supplied via the encryption key selector 150. The encryption or decryption operation is performed in blocks.

The operation mode selector 220 selects an operation mode for the channel indicated by the channel information S1 received from the operation channel control section 130 among operation modes preset for the respective channels (ch-1 operation mode to ch-n operation mode), and outputs the selected operation mode to the operation circuit 210 as the operation mode signal S2.

In the data processing device 200 described above, the encryption (or decryption) operation processing can be performed with one operation circuit 210 in a time-division manner. It is therefore possible to provide a multi-functional data processing device small in circuit scale that can accept a plurality of channels requiring different operation modes.

### Embodiment 3

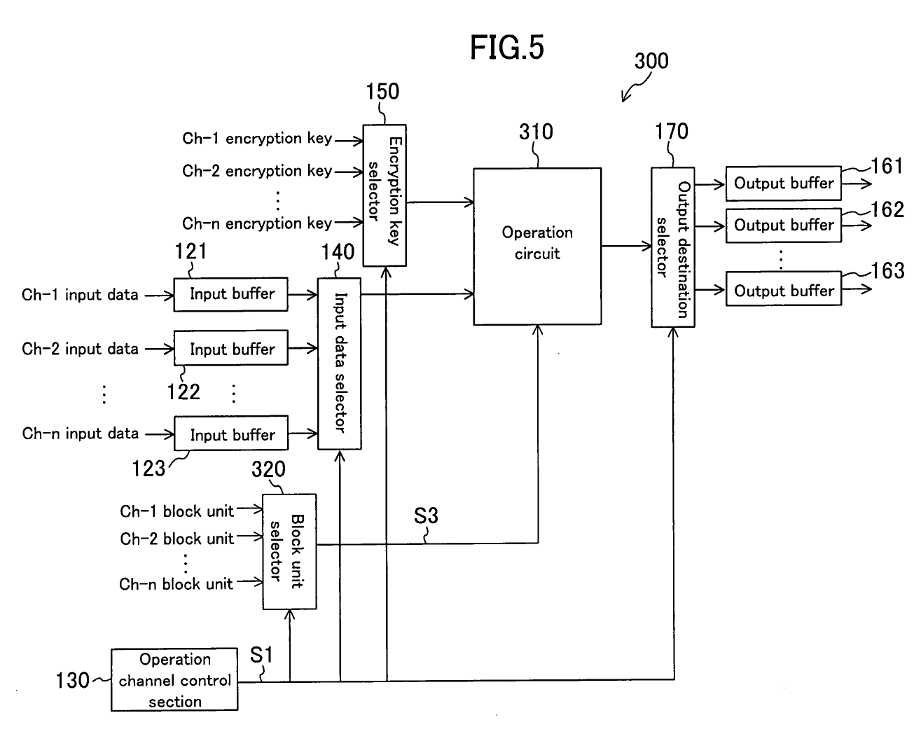

FIG. 5 is a block diagram of a data processing device 300 of Embodiment 3 of the present invention. Referring to FIG. 5, the data processing device 300 is different from the data processing device 100 in that a block unit selector 320 is additionally provided and also an operation circuit 310 is provided in place of the operation circuit 110.

The operation circuit 310 is an operation circuit capable of performing encryption or decryption operation based on a plurality of types of block units (encryption key lengths). The types of block units for the operation are switched to one another according to a block unit signal S3 (to be described later) output from the block unit selector 320. The block units are defined under the block encryption schemes. For example, AES specifies block units of 128 bits, 192 bits and 256 bits.

The block unit selector 320 selects a block unit for the channel indicated by the channel information S1 output from the operation channel control section 130 among block units preset for the respective channels (ch-1 block unit to ch-n block unit), and outputs the selected block unit to the operation circuit 310 as the block unit signal S3.

In the data processing device 300 described above, the encryption or decryption operation processing based on different block units can be performed with one operation circuit 310 in a time-division manner. It is therefore possible to implement a multi-functional data processing device small in circuit scale that can accept a plurality of channels requiring encryption or decryption based on different block units.

### Embodiment 4

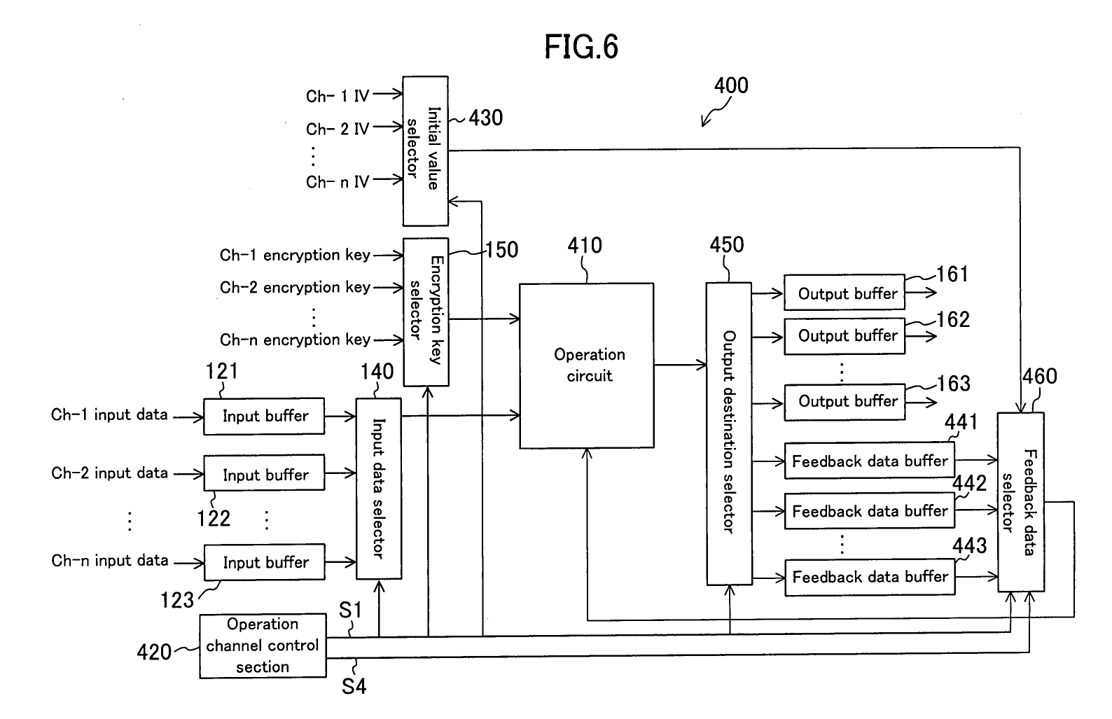

FIG. 6 is a block diagram of a data processing device 400 of Embodiment 4 of the present invention. Referring to FIG. 6, the data processing device 400 is different from the data processing device 100 in that an operation circuit 410, an operation channel control circuit 420 and an output destination selector 450 are provided in place of the operation circuit 110, the operation channel control section 130 and the output destination selector 170, respectively, and also an initial value selector 430, feedback data buffers 441 to 443 and a feedback data selector 460 are additionally provided.

The operation circuit 410 receives the result of encryption (or decryption) or information obtained in the course of processing of the encryption or decryption if block-unit encryption or decryption has already been performed, or receives a predetermined initial value if no encryption or decryption has yet been performed, as feedback data, and encrypts or decrypts input data using the feedback data and an encryption key supplied.

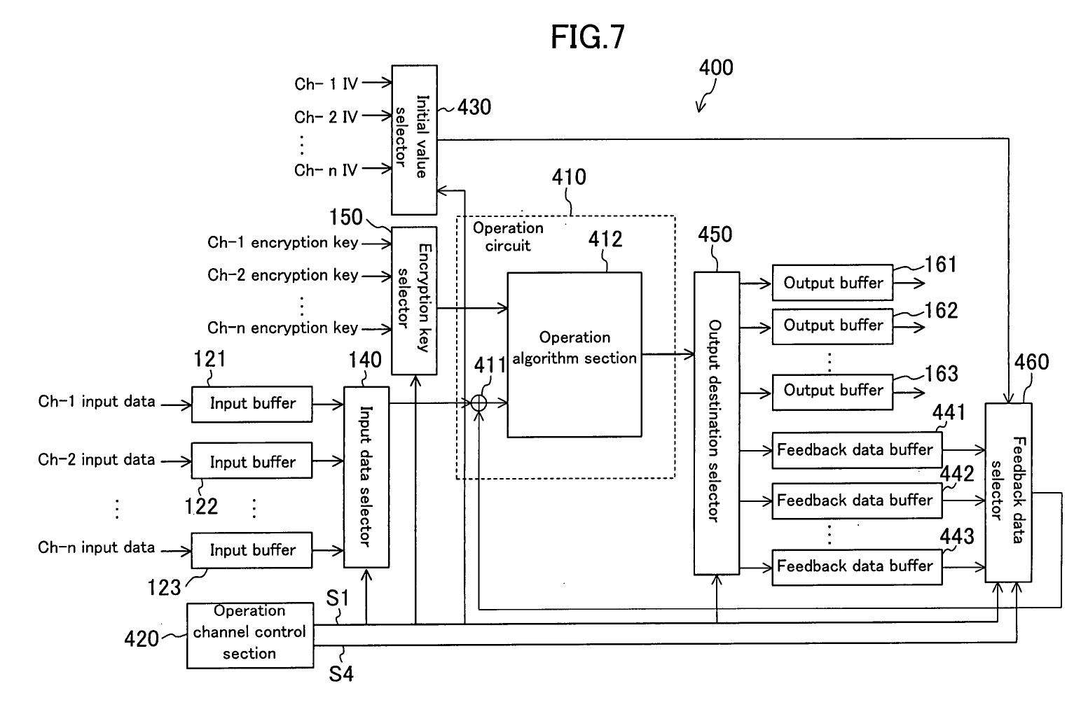

FIG. 7 shows an example of the data processing device 400 in which the operation circuit 410 is configured to support CBC-mode encryption operation processing under a block encryption scheme, for example. In this example, the operation circuit 410 includes an exclusive OR circuit 411 and an operation algorithm section 412.

The exclusive OR circuit 411 operates exclusive OR between the feedback data and the input data and outputs the result to the operation algorithm section 412.

The operation algorithm section 412, which is a circuit portion for performing encryption operation according to an algorithm of a block encryption scheme such as DES and AES, for example, encrypts the output of the exclusive OR circuit 411 and outputs the result.

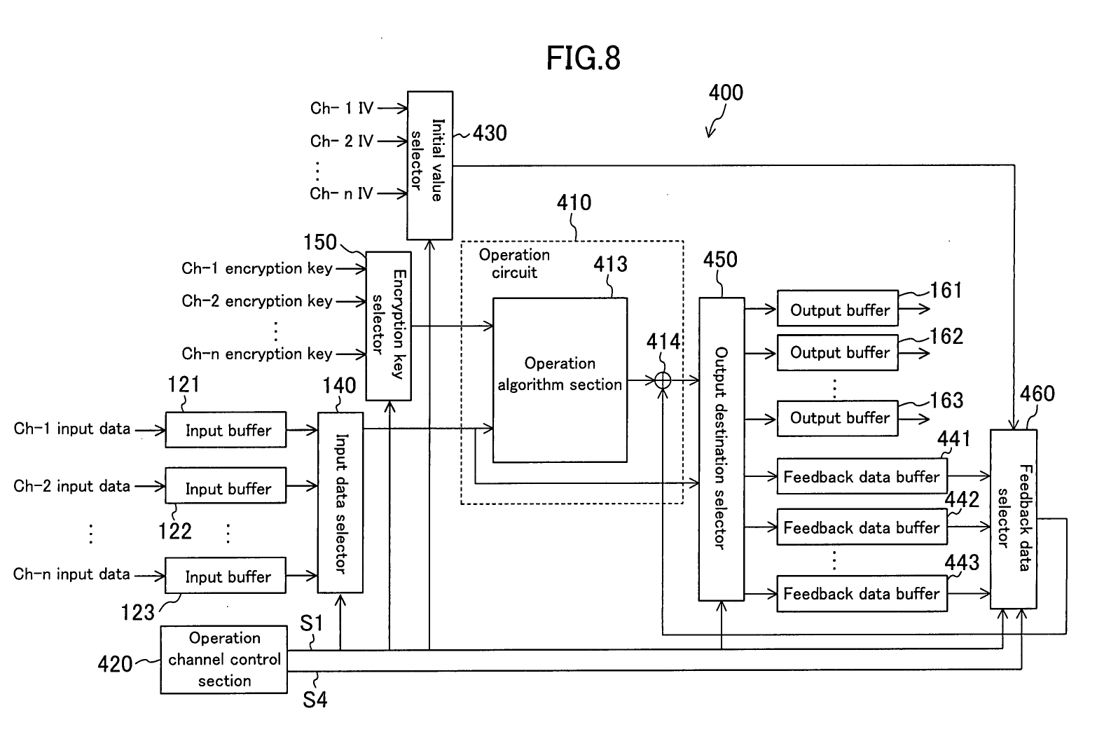

FIG. 8 shows an example of the data processing device 400 in which the operation circuit 410 is configured to support CBC-mode decryption operation processing, for example. In this example, the operation circuit 410 includes an operation algorithm section 413 and an exclusive OR circuit 414.

The operation algorithm section 413 decrypts the input data received via the input data selector 140 with the encryption key received via the encryption key selector 150.

The exclusive OR circuit 414 computes exclusive OR between the output of the operation algorithm section 413 and the feedback data and outputs the result.

As described above, the encryption use modes in the block encryption schemes are attained by combining the operation algorithm section with a simple circuit such as an exclusive OR circuit and a selector. It is therefore possible to provide functions of a plurality of encryption use modes for one operation circuit.

The operation channel control section 420 not only selects a channel of which input data should be processed and outputs the selected channel number as the channel information S1, but also asserts an IV enable signal S4 to be output to the feedback data selector 460 if the data from the channel in question is head data in a sequence of encryption or decryption processing.

The initial value selector 430 selects an initial value (initial vector, IV) preset for each channel according to the channel information S1, and outputs the selected IV to the feedback data selector 460.

The feedback data buffers 441 to 443, provided for the respective channels, hold the result of encryption (or decryption) for the corresponding channels or information obtained in the course of the encryption or decryption processing.

The output destination selector 450 outputs the processing result from the operation circuit 410 to an output buffer (any of the output buffers 161 to 163) corresponding to the channel indicated by the channel information S1. In addition, the output destination selector 450 sends data to be fed back for the next operation (encryption or decryption) for the channel currently under processing to a feedback data buffer (any of the feedback data buffers 441 to 443) corresponding to the channel indicated by the channel information S1 to be held therein.

The feedback data selector 460 selects the IV output from the initial value selector 430 if the IV enable signal S4 is active, and outputs the result to the operation circuit 410 as the feedback data. If the IV enable signal S4 is inactive, the feedback data selector 460 selects feedback data for the channel indicated by the channel information S1 among the feedback data buffers 441 to 443, and outputs the result to the operation circuit 410 as the feedback data.

In the data processing device 400 configured as described above, head data in a sequence of stream data (plaintext in the case of encryption or ciphertext in the case of decryption) is first input. Once data of the block unit is stored in the input buffers 121 to 123, the input buffers 121 to 123 respectively issue the operation requests (S31 to S33) to the operation channel control section 420.

When detecting an operation request from any of the input buffers 121 to 123, the operation channel control section 420 selects a channel for which encryption operation is to be performed among channels that have issued their operation requests, and outputs the channel information S1. Also, if detecting that the data for the channel in question is head in a sequence of encryption processing, the operation channel control section 420 asserts the IV enable signal S4 to be output to the feedback data selector 460. The initial value selector 430 selects the IV for the channel indicated by the channel information S1 and outputs the selected IV to the feedback data selector 460. The feedback data selector 460 selects the IV received from the initial value selector 430 if detecting that the IV enable signal S4 is active, and outputs the IV to the operation circuit 410 as the feedback data.

The operation circuit 410 performs encryption or decryption operation processing for the input data received from the input data selector 140 with the feedback data (IV in this case) received via the feedback data selector 460 and the encryption key received from the encryption key selector 150.

For example, in the case of performing encryption operation processing with the operation circuit 410 configured as shown in FIG. 7, the exclusive OR circuit 411 computes exclusive OR between the input data and the feedback data, and the operation algorithm section 412 encrypts the output from the exclusive OR circuit 411 and outputs the result to the output destination selector 450.

In the case of performing decryption operation processing with the operation circuit 410 configured as shown in FIG. 8, the operation algorithm section 413 decrypts the input data with the encryption key, and the exclusive OR circuit 414 computes exclusive OR between the output from the operation algorithm section 413 and the feedback data and outputs the result to the output destination selector 450 as the decryption result.

Once the operation with the operation circuit 410 is terminated, the output destination selector 450 sends the processing result from the operation circuit 410 to the output buffer (any of the output buffers 161 to 163) corresponding to the channel indicated by the channel information S1 to be stored therein. In addition, the output destination selector 450 sends the data to be fed back for the next operation (encryption or decryption) for the channel currently under processing to the feedback data buffer (any of the feedback data buffers 441 to 443) corresponding to the channel indicated by the channel information S1.

Thereafter, when data of the next block unit is given to the same channel, the operation channel control section 420 outputs the channel information S1. Because the data for this channel is not head in a sequence of encryption processing this time, the operation channel control section 420 negates the IV enable signal S4 to be output to the feedback data selector 460.

Receiving the inactive IV enable signal S4, the feedback data selector 460 selects the feedback data stored in the feedback data buffer corresponding to the channel currently under processing, and outputs the selected data to the operation circuit 410 as the feedback data.

The operation circuit 410 again performs operation processing (encryption or decryption operation processing) for the input data received from the input data selector 140 with the feedback data (feedback data stored in the feedback data buffer corresponding to the channel currently under processing in this case) received via the feedback data selector 460 and the encryption key received from the encryption key selector 150. Thereafter, the processing described above is repeated up to the end of the sequence of stream data, to thereby accomplish the CBC-mode encryption or decryption processing.

As described above, in Embodiment 4, it is possible to implement a data processing device that can enhance the encryption strength by performing encryption or decryption in a chain for input data from a plurality of channels on a smaller circuit scale.

### Embodiment 5

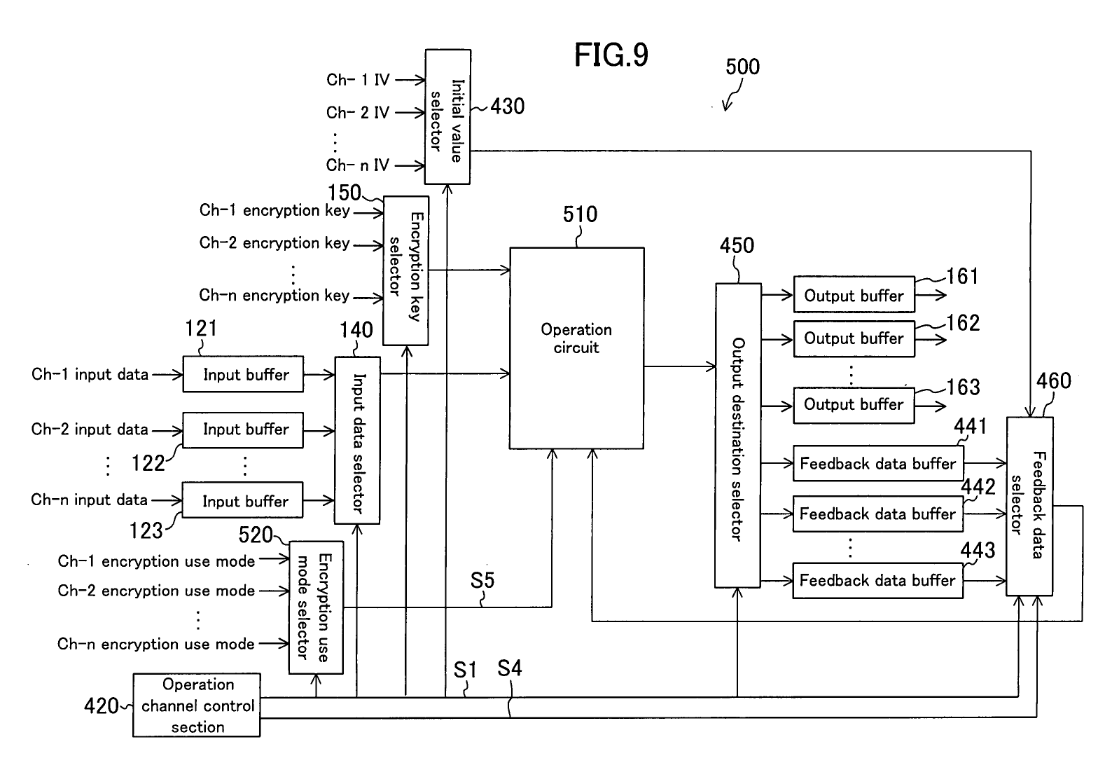

FIG. 9 is a block diagram of a data processing device 500 of Embodiment 5 of the present invention. Referring to FIG. 9, the data processing device 500 is different from the data processing device 400 in that an operation circuit 510 is provided in place of the operation circuit 410 and also an encryption use mode selector 520 is additionally provided.

The operation circuit 510 is an operation circuit having functions of a plurality of encryption use modes, in which encryption use modes used for operation processing are switch to one another according to an input encryption use mode signal S5 (to be described later).

The encryption use mode selector 520, which receives information indicating the encryption use modes (ch-1 encryption use mode to ch-n encryption use mode) preset for the respective channels (channels 1 to n), selects an encryption use mode corresponding to the channel currently under processing according to the channel information S1 output from the operation channel control section 420, and outputs the selected one to the operation circuit 510 as the encryption use mode signal S5.

In the data processing device 500 described above, encryption or decryption processing in different encryption use modes can be performed with one operation circuit in a time-division manner. Thus, a multi-functional data processing device capable of accepting a plurality of channels different in encryption use mode can be implemented on a small circuit scale.

### Embodiment 6

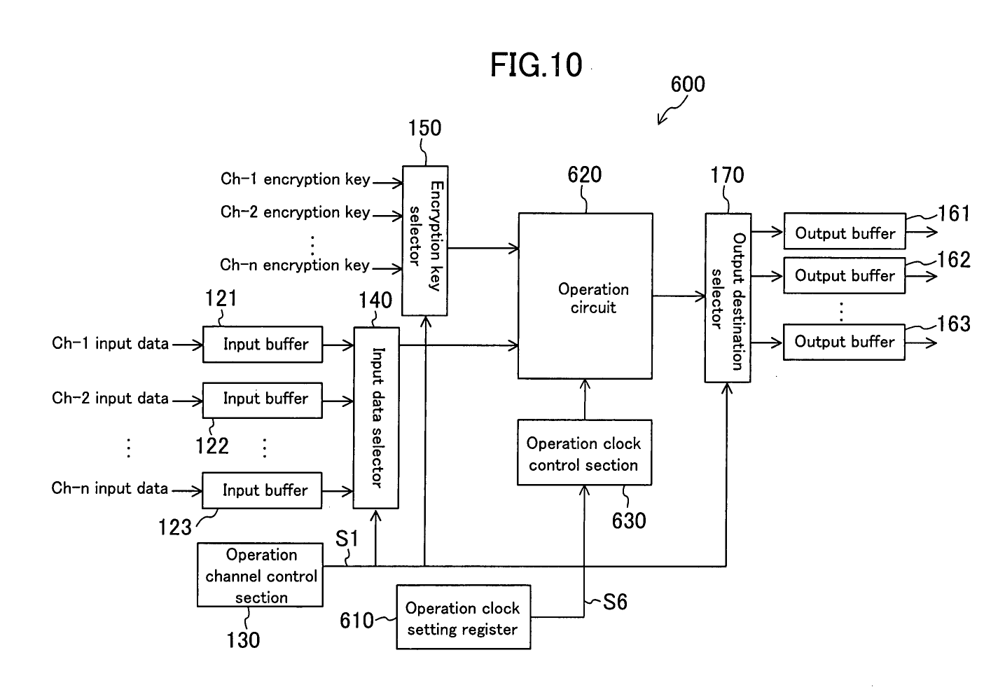

FIG. 10 is a block diagram of a data processing device 600 of Embodiment 6 of the present invention. Referring to FIG. 10, the data processing device 600 is different from the data processing device 100 in that an operation clock setting register 610 and an operation clock control section 630 are additionally provided and also an operation circuit 620 is provided in place of the operation circuit 110.

The operation clock setting register 610 is a register for setting the frequency of a clock signal (operation clock) used in the operation circuit 620 for encryption or decryption processing, which outputs clock information S6 responsive to the set clock frequency to the operation clock control section 630. The clock frequency set in the operation clock setting register 610 should be one satisfying the processing capability required for the operation circuit 620 (for example, processing capability derived from the number of valid channels and the bands of the channels). The setting of the clock frequency may otherwise be made by selecting one among a plurality of clock frequency setting candidates preset in the operation clock setting register 610.

The operation circuit 620 performs encryption or decryption processing using the operation clock having the frequency responsive to an input control signal.

The operation clock control section 630 outputs the clock signal having a predetermined frequency responsive to the clock information S6 to the operation circuit 620.

With the configuration described above, encryption or decryption processing for a plurality of channels can be performed with one operation circuit, and moreover, with the setting of the operation clock according to the number of valid channels and the bands of the channels, power consumption of the operation circuit can be delicately controlled.

### Embodiment 7

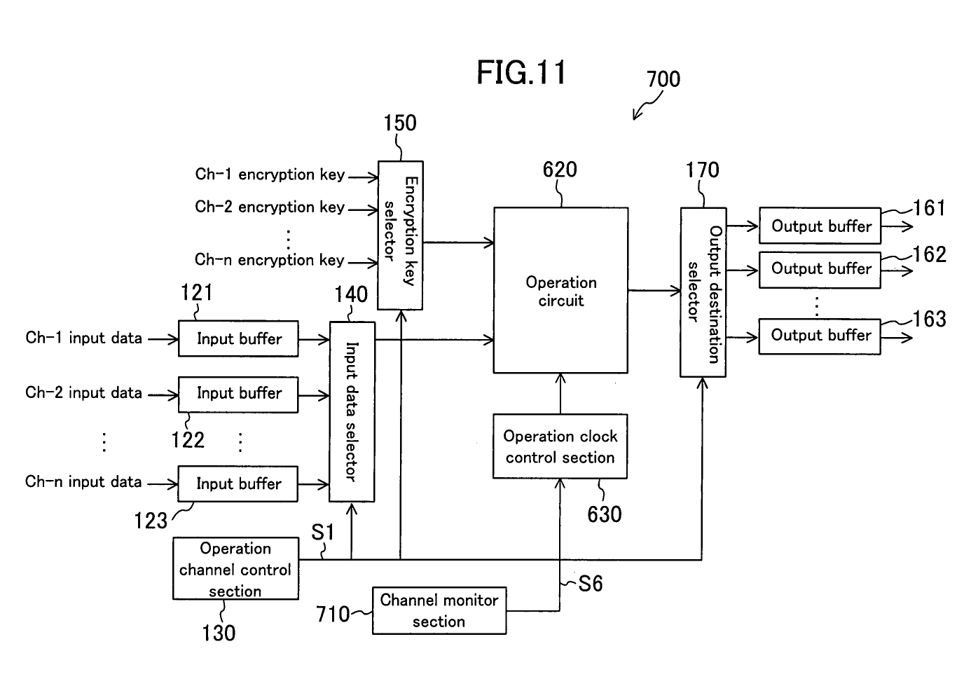

FIG. 11 is a block diagram of a data processing device 700 of Embodiment 7 of the present invention. Referring to FIG. 11, the data processing device 700 is different from the data processing device 600 in that a channel monitor section 710 is provided in place of the operation clock setting register 610.

The channel monitor section 710 detects valid channels among a plurality of acceptable channels, calculates the clock frequency required for the operation circuit 620 from the number of valid channels and the bands of the channels, and outputs the clock information S6 responsive to the calculated clock frequency to the operation clock control section 630.

With the configuration described above, encryption or decryption processing for a plurality of channels can be performed with one operation circuit, and moreover the operation clock can be changed automatically according to the number of valid channels and the bands of the channels. In other words, power consumption of the operation circuit can be delicately controlled.

<Alteration to Operation Channel Control Section>

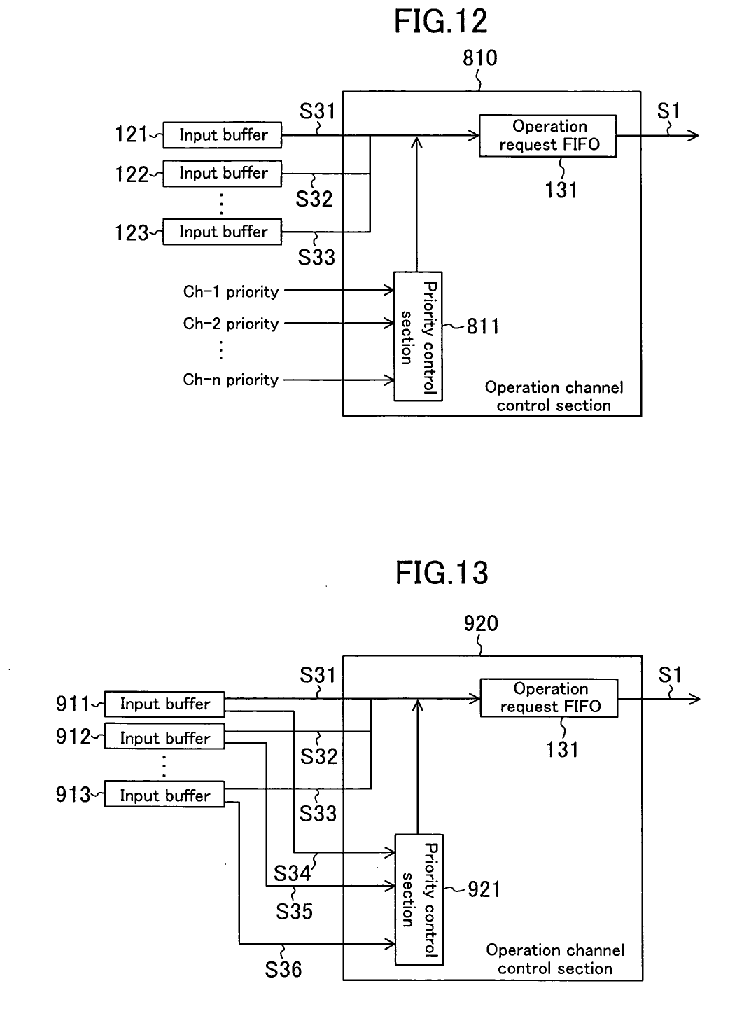

The operation channel control sections in the above embodiments may be configured to determine the order of the operation processing according to the priorities preset for the respective channels. FIG. 12 is a block diagram of an operation channel control section 810, which is composed of the operation request FIFO 131 and a priority control section 811.

Once detecting any of the operation requests S31 to S33, the priority control section 811 stores the detected operation request in the operation request FIFO 131 according to the priorities preset for the respective channels. More specifically, the priority control section 811 is given information (ch-1 priority to ch-n priority) indicating the priorities preset for the channels. The priority control section 811 selects the priority for a channel that has issued an operation request based on the input information, and if there exists an operation request for a channel lower in priority than the current channel in the operation request FIFO 131, puts the current operation request at a position in the operation request FIFO 131 preceding the operation request for the channel lower in priority.

With the above configuration, since a higher priority may be given to a channel having a wide band while a lower priority being given to a channel having a narrow band, for example, a data processing device capable of accepting a plurality of channels handling data in different bands can be implemented.

<Another Alteration to Operation Channel Control Section>

The operation channel control sections in the above embodiments may otherwise be configured to determine the order of the operation processing according to the stored data amounts of the input buffers. FIG. 13 is a block diagram of an operation channel control section 920, which is composed of the operation request FIFO 131 and a priority control section 921. In this case, as shown in FIG. 13, input buffers 911 to 913 are used in place of the input buffers 121 to 123.

The input buffers 911 to 913 not only output the operation requests S31 to S33 described above, but also output signals indicating the respective stored data amounts (stored data amount signals S34 to S36) to the priority control section 921 of the operation channel control section 920.

When receiving any of the operation requests S31 to S33, the priority control section 921 checks the stored data amount of the corresponding one of the input buffers 911 to 913 with its stored data amount signal (any of S34 to S36). If the stored data amount exceeds a predetermined set value, the priority control section 921 raises the priority of the corresponding channel, and, if there exists an operation request for a channel lower in priority than the current channel in the operation request FIFO 131, the priority control section 921 puts the current operation request at a position in the operation request FIFO 131 preceding the operation request lower in priority.

With the above configuration, the priorities of the operation processing can be automatically adjusted with the stored data amounts of the input buffers, and thus occurrence of an overflow in an input buffer can be prevented.

As described above, the data processing device according to the present invention has an effect of permitting encryption (or decryption) processing of real time data from a plurality of channels on a smaller circuit scale, and thus is useful as a data processing device and data processing method for performing encryption or decryption under a block encryption scheme.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A data processing device for performing operation processing of at least either encryption or decryption for data input from a plurality of input channels, the device comprising:
an operation circuit for performing the operation processing for given data with a given encryption key by a block unit having a predetermined size;
an input buffer provided for each of the input channels for temporarily storing data received from the corresponding input channel;
an operation channel control section for selecting an input channel for which the operation processing is to be performed in a time-division manner and outputting channel information indicating the selected input channel;
an encryption key selector for outputting an encryption key responsive to the channel information to the operation circuit;
an input data selector for selecting an input buffer corresponding to the input channel indicated by the channel information and outputting data stored in the selected input buffer to the operation circuit;
an output buffer provided for each of the input channels for temporarily storing the result of the operation processing performed for data input from the corresponding input channel; and
an output destination selector for selecting an output buffer corresponding to the input channel indicated by the channel information and outputting the result of the operation processing to the selected output buffer.

2. The device of claim 1, further comprising an operation mode selector for notifying the operation circuit of an operation mode selected among operation modes preset for the respective input channels according to the channel information, the operation mode being an operation mode for performing encryption and an operation mode for performing decryption,
wherein the operation circuit is configured to perform the operation processing according to the operation mode notified of by the operation mode selector.

3. The device of claim 1, wherein the operation circuit is configured to perform the operation processing by a plurality of types of block units.

4. The device of claim 3, further comprising a block unit selector for notifying the operation circuit of a block unit selected among block units preset for the respective input channels according to the channel information,
wherein the operation circuit is configured to perform the operation processing according to the block unit notified of by the block unit selector.

5. The device of claim 1, further comprising:
a feedback data buffer provided for each of the input channels for temporarily storing the result of the operation processing;
a feedback data selector for outputting the result of the operation processing stored in a feedback data buffer corresponding to the input channel indicated by the channel information or a given initial value to the operation circuit; and
an initial value selector for outputting the initial value that is a value responsive to the channel information to the feedback data selector,
wherein the operation circuit is configured to perform the operation processing for given data with the output of the feedback data selector and a given encryption key.

6. The device of claim 5, wherein the operation circuit has functions of a plurality of different encryption use modes.

7. The device of claim 6, further comprising an encryption use mode selector for notifying the operation circuit of an encryption use mode selected among the encryption use modes preset for the respective input channels according to the channel information,
wherein the operation circuit is configured to perform the operation processing according to the encryption use mode notified of by the encryption use mode selector.

8. The device of claim 1, wherein the operation channel control section is configured to select an input channel for which the operation processing is to be performed in a manner of an input channel corresponding to an input buffer in which data of the block unit has been stored first being selected first.

9. The device of claim 1, wherein the operation channel control section is configured to select an input channel for which the operation processing is to be performed according to priorities given to the respective input channels.

10. The device of claim 1, wherein the operation channel control section is configured to select an input channel for which the operation processing is to be performed according to priorities given based on the stored data amounts of the input buffers.

11. The device of claim 1, further comprising an operation clock control section for controlling the frequency of an operation clock for the operation circuit.

12. The device of claim 11, further comprising a channel monitor section for detecting the number of valid input channels among the plurality of input channels, selecting an operation clock for the operation circuit according to the detected number of channels, and notifying the operation clock control section of the selected operation clock,
wherein the operation clock control section is configured to change the operation clock for the operation circuit according to the notification from the channel monitor section.

13. A data processing method for performing operation processing of at least either encryption or decryption for data input from a plurality of input channels, the method comprising the steps of:
performing the operation processing with an operation circuit for performing the operation processing for given data with a given encryption key by a block unit having a predetermined size (operating step);
temporarily storing data input from the input channels in input buffers provided for the respective input channels (inputting step);
detecting that data of the block unit has been stored in any of the input buffers (detecting step);
issuing an operation request to the operation circuit once storing of data of the block unit in the input buffer has been detected in the detecting step (operation request issuing step);
storing the operation request in an operation request buffer (operation request storing step)
selecting one operation request from operation requests stored in the operation request buffer in a time-division manner and outputting channel information indicating the input channel corresponding to the selected operation request (operation channel control step);
outputting an encryption key responsive to the channel information to the operation circuit (encryption key outputting step);
selecting an input buffer corresponding to the input channel indicated by the channel information and outputting data stored in the selected input buffer to the operation circuit (input data selecting step);
selecting an output buffer corresponding to the input channel indicated by the channel information among output buffers provided for the respective input channels and outputting a result of the operation processing to the selected output buffer (outputting step); and
deleting the operation request for the terminated operation processing from the operation request buffer (operation request deleting step).
